(19) United States
(12) Patent Application Publication
(10) Pub. No.: US 2010/0005120 A1
(43) Pub. Date: Jan. 7, 2010

(54) METHOD AND APPARATUS FOR GENERATING MEDIA FILE HAVING MEDIA INFORMATION COMPATIBLE BETWEEN MEDIA FILES HAVING SAME FORMAT, AND METHOD AND APPARATUS FOR EXECUTING THE MEDIA FILE

(75) Inventors: Hwa-jung KIM, Suwon-si (KR); Sun-hee YOUM, Seoul (KR); Ga-hyun RYU, Suwon-si (KR); Hyun-wook KIM, Suwon-si (KR); Kyung-sun CHO, Seoul (KR); Ju-hee SEO, Hwaseong-si (KR); Jong-hwa KIM, Suwon-si (KR); Mi-hwa PARK, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/496,955

(22) Filed: Jul. 2, 2009

(30) Foreign Application Priority Data
Jul. 2, 2008 (KR) 10-2008-0063968

(51) Int. Cl. G06F 17/30

(52) U.S. Cl. 707/104.1; 707/E17.009

(57) ABSTRACT

Provided is a method of executing a media file including at least one media resource, the method including: importing the media file including the media resource and media information that includes at least one digital item about the media resource, at least one template, and at least one application; and selecting one piece of the media information, and executing an event of one or more media resources associated with the media information, based on the selected one piece of the media information, wherein the digital item includes the media resource and identification information of each media resource, the template includes an event of the at least one digital item and execution environment information of the event, the application includes association information of the template and the digital item, and the media information is adapted to be imported and exported.

### CROSS-REFERENCE TO RELATED PATENT APPLICATION

This application claims priority from Korean Patent Application No. 10-2008-0063968, filed on Jul. 2, 2008, in the Korean Intellectual Property Office, the disclosure of which is incorporated herein in its entirety by reference.

### BACKGROUND OF THE INVENTION

1. Field of the Invention

The present invention relates to generating and executing a media file, and more particularly, to generating a media file that can be edited by a user and executing various applications using the generated media file.

2. Description of the Related Art

As commercialized media contents and devices using the media contents vary, compatibility and accessibility of the media contents are required. As users wish to widely use such media contents, a desire to combine and rearrange conventional contents and a requirement to share contents generated by the users with other users are increasing. For example, user created contents (UCC) and user modified contents (UMC) are widely used. Examples of a media content format include an ASF (advanced systems format or active streaming format) file format, a tag based file format, and a box based file format.

FIG. 1 is a diagram illustrating a conventional ASF file format. The conventional ASF file format specializes in transmitting audio/video (AV) data in real-time and reproducing the AV data in a local environment. In the conventional ASF file format, content is stored/reproduced in units of packets by multiplexing the content, and is streamed in real-time without changing the format of the content. As illustrated in FIG. 1, the conventional ASF file format includes a header object, a data object, and other top-level objects. The header object includes a file properties object and stream properties objects 1 through N as lower level objects, the data object includes data packets 1 through M as lower level objects, and the other top-level objects include index objects 1 through K and simple index objects 1 through L. However, there have been no further technical updates since a related specification was published in 2004, and since data is stored after being multiplexed, it is difficult to rearrange content in real time by using a general processor.

FIG. 2 is a diagram illustrating a conventional tag based file format.

The conventional tag based file includes various types of media, wherein a fla file format is used as a source file, and an swf file format is used as a format for compression/distribution so as to reproduce an item of content. As illustrated in FIG. 2, at least one tag provides information about media data. A content manufacturer prepares and distributes content in a desired format via an action script preparation. However, since the source file and the file format for reproducing content are not identical, real time editing is not possible because it is difficult for a user to amend the content while reproducing the content. In addition, only an expert can generate the content.

FIG. 3 is a diagram illustrating a conventional box based file format.

The conventional box based file format includes various types of media like the conventional tag based file format, and can be enlarged by separately including a function required for a certain device or service. For example in the conventional box based file format, a user input required in reproduction is processed via a scene representation technique, such as Binary Format for Scenes (BIFS) and Lightweight Scene Representation (LASeR) of MPEG-4. The conventional box based file format of FIG. 3 includes a file type information (ftyp) box, an mdat box to which media data is inserted, a moov box to which various information about the media data in the mdat box is inserted, and a meta box to which various information of a media file is inserted. However, the box based file format is optimized to reproduce and transmit AV content, and thus the AV content cannot be amended. Also, a special production tool and related knowledge are required to generate and edit the AV content. Accordingly, a general user cannot generate/edit content.

### SUMMARY OF THE INVENTION

An aspect of the present invention provides a method that enables a user to easily create an application for executing important functions related to content, define the application and a file format of a media file to which media resources are inserted, and generate and execute a media file having such a file format.

According to an aspect of the present invention, there is provided a method of generating a media file, the method including: inserting a digital item including identification information of a media resource to the media file; inserting a template including an event for the digital item and execution environment information of the event to the media file; and inserting an application including association information of the template and the digital item to the media file, wherein media information including the digital item, the template, and the application is adapted to be imported and exported.

The media information and the media resource associated with the media information may be simultaneously imported.

The media information and the media resource associated with the media information may be simultaneously exported.

A user may perform at least one of inserting, deleting, searching for, and publishing of at least one of the media resource and the media information.

In the inserting of the template, the digital item may be associated with the template, and the event may be executed for the digital item.

An event of the template may include an operation of searching for a digital item so as to determine the digital item associated with the template, an operation of displaying the searched for digital item, and an operation of selecting at least one of the displayed digital items.

The event of the template may further include an operation of inserting an application including association information of the template and the selected digital item to the media file.

An event of the application may include an operation of executing an event for a digital item associated with a template of the application, based on the template.

The media file may follow a file format independently including a first area for the digital item, a second area for the template, and a third area for the application.

According to another aspect of the present invention, there is provided a method of executing a media file including at least one media resource, the method including: importing the media file including the at least one media resource and media information that includes at least one digital item about the media resource, at least one template, and at least one application; and selecting one piece of the media information, and executing an event of the at least one media resource associated with the media information, based on the selected one piece of the media information, wherein the digital item includes the media resource and identification information of each of the at least one media resource, the template includes an event of the at least one digital item and execution environment information of the event, the application includes association information of the at least one template and the at least one digital item, and the media information is adapted to be imported and exported.

The method may further include importing the media information and the at least one media resource associated with the media information.

The method may further include exporting the media information and the at least one media resource associated with the media information.

The media file may follow a file format independently including a first area for the at least one digital item, a second area for the at least one template, and a third area for the at least one application.

The selecting one piece of the media information and the executing of the event may include a user calling a media information interface for accessing at least one of the first area for the at least one digital item, the second area for the at least one template, and the third area for the at least one application.

The media information interface may display the media information in a first user accessible area for the at least one digital item, a second user accessible area for the at least one template, and a third user accessible area for the at least one application for the user to select the media information.

The media information interface may be a kind of template.

The selecting one piece of the media information and the executing of the event may further include: selecting one piece of the media information based on the user direction received through the media information interface; and performing at least one of inserting, deleting, exporting, importing, searching for, and publishing of the selected one piece of the media information.

The selecting one piece of the media information and the executing of the event may further include: selecting one piece of the media information based on the user direction received through the media information interface; and executing of the event of the selected media information.

The selecting of the media information and executing of the event may further include calling the media information interface, when executing of the event of the selected media information is completed.

The selecting one piece of the media information and the executing of the event may include: selecting a template from the media information; searching for one or more digital items so as to determine the searched one or more digital items to be associated with the selected template; displaying the searched one or more digital items; selecting the displayed one or more digital items; and inserting an application comprising association information of the selected one or more digital items and the selected template to the media file.

The selecting one piece of the media information and the executing of the event may include: selecting an application from the media information; and the executing of an event for a digital item associated with a template of the application, based on the template.

When the association information of the application changes, the changed application may be inserted to the media file by updating the association information of the template and the digital item according to the changed association information of the template and the digital item.

When the association information of the application changes, the application may be updated by recording only the changed association information from information about a digital media associated with the template of the application, and the updated application may be inserted to the media file.

According to another aspect of the present invention, there is provided an apparatus for generating a media file including at least one media resource, the apparatus including: a digital item inserter which inserts at least one a digital item including identification information of each of the at least one media resource to the media file; a template inserter which inserts at least one template including an event for the at least one digital item and execution environment information of the event to the media file; and an application inserter, which inserts at least one application including association information of the at least one template and the at least one digital item to the media file, wherein media information including the at least one digital item, the at least one template, and the at least one application is adapted to be imported and exported.

The media information and the at least one media resource associated with the media information may be simultaneously imported.

The media information and the at least one media resource associated with the media information may be simultaneously exported.

A user may perform at least one of inserting, deleting, searching for, and publishing of at least one of the at least one media resource and the media information.

In the template inserter, at least one digital item may be associated with each template, and at least one event may be executed for each digital item.

An event of the template may include an operation of searching for a digital item so as to determine the digital item associated with the template, an operation of displaying the searched for digital item, and an operation of selecting at least one of the displayed digital items.

The event of the template may further include an operation of inserting an application including association information of the template and the selected digital item to the media file.

An event of the application may include an operation of executing an event for a digital item associated with a template of the application, based on the template.

The media file may follow a file format independently including an area for the digital item, an area for the template, and an area for the application.

According to another aspect of the present invention, there is provided an apparatus for executing a media file including at least one media resource, the apparatus including: a media file importer which imports the media file including the media resource and media information that includes at least one digital item about the media resource, a template, and at least one application; and an event executer, which selects one piece of the media information and executes an event of a media resource associated with the media information, based on the selected one piece of the media information, wherein the digital item includes the media resource and identification information of each media resource, the template includes an event of the at least one digital item and execution environment information of the event, the application includes association information of the template and the digital item, and the media information is adapted to be imported and exported.

The apparatus may further include an external media information importer, which imports the media information and a media resource associated with the media information.

The apparatus may further include an external media information exporter, which exports the media information and a media resource associated with the media information.

The media file may follow a file format independently including an area for the digital item, an area for the template, and an area for the application.

The event executer may include a media information interface caller, which calls a media information interface for accessing at least one of the area for the digital item, the area for the template, and the area for the application.

The media information interface may display media information in the accessible area for the digital item, the accessible area for the template, and the accessible area for the application for the user to select the media information.

The media information interface may be a kind of template.

The event executer may select media information based on a user direction received through the media information interface and perform at least one of inserting, deleting, exporting, importing, searching for, and publishing the selected media information.

The event executer may select media information based on a user direction received through the media information interface and execute an event of the selected media information.

The event executer may call the media information interface, when executing of the event of the selected media information is completed. The event executer may select a template from the media information, search for digital items so as to determine the digital items to be associated with the template, display the searched for digital items, select at least one of the displayed digital items, and insert an application including association information of the selected digital item and the template to the media file.

The event executer may select an application from the media information, and execute an event for a digital item associated with a template of the application, based on the template.

When information of the application changes, the changed application may be inserted to the media file by updating the association information of the template and the digital item according to the changed association information of the template and the digital item.

When information of the application changes, the application may be updated by recording only the changed information from information about a digital media associated with the template of the application, and the updated application may be inserted to the media file.

According to another aspect of the present invention, there is provided a computer readable recording medium having recorded thereon a computer program for executing the method of generating a media file.

According to another aspect of the present invention, there is provided a computer readable recording medium having recorded thereon a computer program for executing the method of executing a media file.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional ASF file format;

FIG. 2 is a diagram illustrating a conventional tag based file format;

FIG. 3 is a diagram illustrating a conventional box based file format;

FIG. 4 is a block diagram illustrating an apparatus for generating a media file, according to an exemplary embodiment of the present invention;

FIG. 5 is a block diagram illustrating an apparatus for executing a media file, according to an exemplary embodiment of the present invention;

FIG. 6 is a diagram illustrating an example of a digital item;

FIG. 7 is a diagram illustrating an example of a template;

FIG. 8 is a diagram illustrating an example of an application;

FIG. 9 is a diagram illustrating an example of a space for publishing media information;

FIG. 10 is a diagram illustrating an interface between an apparatus for executing a media file and a user, according to an exemplary embodiment of the present invention;

FIG. 11 is a diagram illustrating a media file generated in a box based file format according to an exemplary embodiment of the present invention;

FIG. 12 is a diagram for describing an apparatus for executing a media file executing an event, according to an exemplary embodiment of the present invention;

FIG. 13 is a diagram for describing how content is distributed by a media file, according to an exemplary embodiment of the present invention;

FIG. 14 is a flowchart of a method of generating a media file, according to an exemplary embodiment of the present invention; and

FIG. 15 is a flowchart of a method of executing a media file, according to an exemplary embodiment of the present invention.

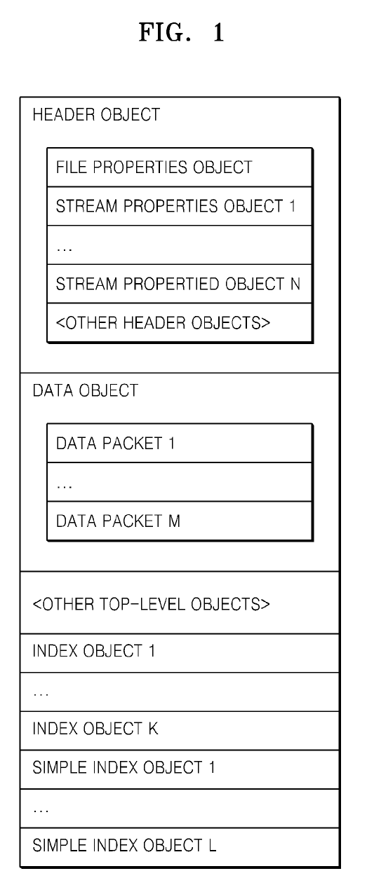

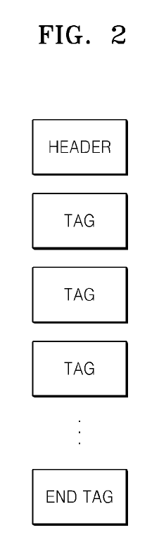

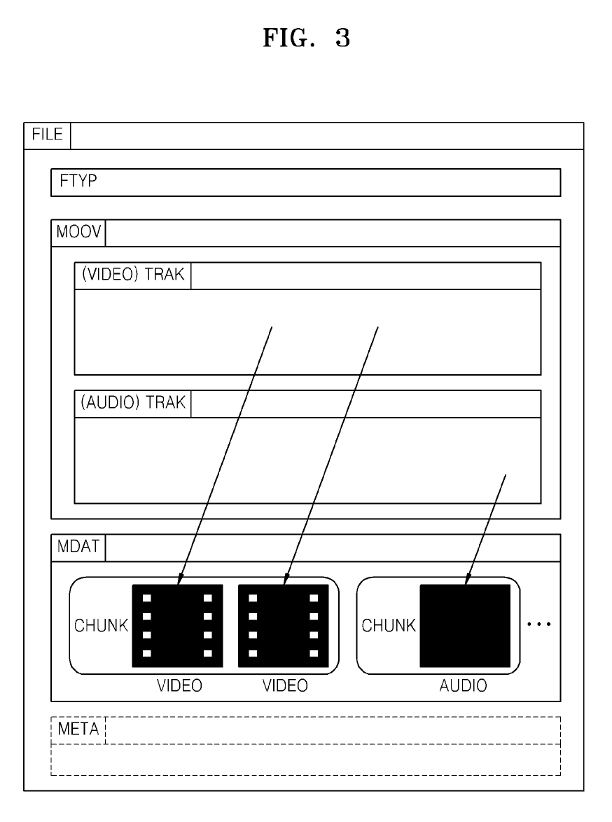

### DETAILED DESCRIPTION OF THE EXEMPLARY EMBODIMENTS OF THE INVENTION

Definitions of terms and concepts required to understand exemplary embodiments of the present invention will now be described.

A digital item is a unit that considers a plurality of unit media resources and description information thereof as one medium.

Events or digital item methods are various functions applicable to a certain type of media information.

A media guide shows media information in a media file format, and provides an interface that is accessible by a user. The user is provided with the media information in the media file format via the media guide, and may search for and use desired media information.

A template establishes and provides an environment wherein a certain function can be performed, via a user input. A user inserts a digital item to an empty space in a template, and generates an intrinsic application of the user by connecting an event for operating the digital item.

An application is a combination of certain media, accomplished by filling an empty space of a template with a digital item, an event, etc. via a user input. A completed application may be published in a media information storage space (media storage) in the same media file format, and re-executed.

A media storage is a media information storage space, which is designed to store a digital item, a template, and an application based on the International Standardization Organization (hereinafter, referred to as ISO) based file format, and to execute functions, such as inserting, deleting, importing, exporting, searching for, and publishing, in addition to functions defined in the template.

An exporting function exports each digital item, a template, and an application in a predetermined format to the outside of a media file, so as to share the digital item, the template, and the application with another user.

An importing function imports a digital item, a template, and an application from another media file to its own media file.

A searching function enables a user to find a desired medium from among a digital item, a template, and an application defined in a media file, by using a tag or identification information defined by the user.

A publishing function stores an application generated by a user in a media file.

A tag is data that provides information about media information additionally given by a user to each digital item, template, and application.

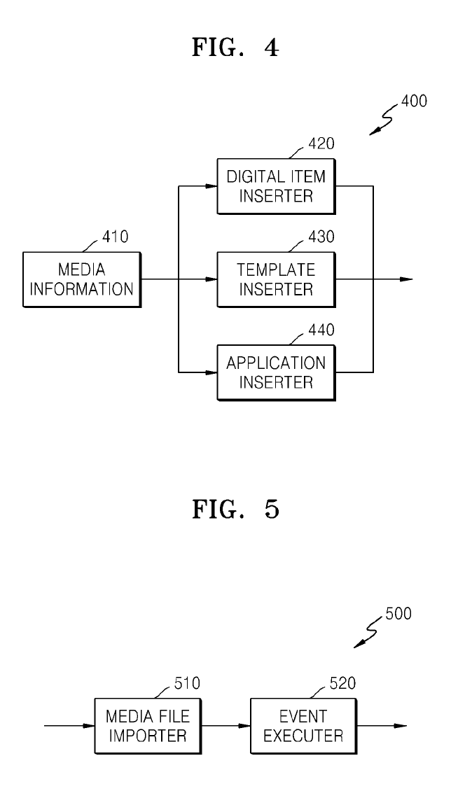

An apparatus for generating a media file and an apparatus for executing a media file according to exemplary embodiments of the present invention will now be described with reference to FIGS. 4 and 5.

FIG. 4 is a block diagram illustrating an apparatus 400 for generating a media file, according to an exemplary embodiment of the present invention.

The apparatus 400 includes a digital item inserter 420, a template inserter 430, and an application inserter 440, which import media information 410.

The media information 410 according to an exemplary embodiment of the present invention is information about media resources of content, such as video, audio, or an image, recorded on a media file, and includes at least one digital item, at least one template, and at least one application.

The digital item includes identification information of an individual media resource.

The template includes an event for the digital item and execution environment information of the event. At least one digital item may be associated with each template, and at least one event may be executed for each digital item associated with a template.

The application includes association information of the template and the digital item.

The digital item inserter 420 inserts the at least one digital item in the media information 410 into the media file, and then exports the media file.

The template inserter 430 inserts the at least one template in the media information 410 into the media file, and then exports the media file.

The application inserter 440 inserts the at least one application in the media information 410 into the media file, and then exports the media file.

The media information 410, i.e. the digital item, the template, and the application may be imported or exported. For example, when there are media files A and B in the same file format, the media file A may import media information of the media file B, and may export media information of the media file A to the media file B. In addition, the media information 410 may be inserted into the media file, even if the media information 410 is not recorded in a media file. Also, the media information 410 may be imported from an external device and inserted into the media file, or exported to the external device.

When the media information 410 is imported or exported, the media resources associated with the media information 410 may be simultaneously imported or exported.

The media information 410 may be inserted into the media file, deleted from the media file, searched for in the media file, and published in the media file by a user. Moreover, such operations may be simultaneously performed on the media resources associated with the media information 410.

The inserting, deleting, searching for, publishing, importing, and exporting of the media information 410 are events about the media information 410.

An event of the template may include an operation of searching for a digital item so as to determine the digital item associated with the template, an operation of displaying the searched digital item, and an operation of selecting at least one of the displayed digital items.

The event of the template may further include an operation of inserting an application generated by associating the selected digital item and the template.

An event of the application may include an operation of executing an event for a digital item associated with a template of the application, based on the template.

The media file generated by the apparatus 400 may follow a file format independently including an area for a digital item, an area for a template, and an area for an application.

FIG. 5 is a block diagram illustrating an apparatus 500 for executing a media file, according to an exemplary embodiment of the present invention.

The apparatus 500 includes a media file importer 510 and an event executer 520.

The media file importer 510 imports the media file having recorded thereon media resources and media information including a digital item, a template, and an application associated with the media resources, and exports the media file to the event executer 520. The media information may include at least one digital item, at least one template, and at least one application. The concepts of the digital item, the template, the application, and the media information are identical to those of the apparatus 400.

The apparatus 500 may import the media information and media data associated with the media information. Also, the apparatus 500 may export the media information and the media data associated with the media information.

The event executer 520 selects one piece of the media information, and executes events about media resources associated with the media information, based on the selected media information.

The digital file imported to the media file importer 510 may follow a file format independently including an area for a digital item, an area for a template, and an area for an application. In this case, according to an exemplary embodiment of the event executer 520, a user may call a media information interface for accessing at least one of the area for a digital item, the area for a template, and the area for an application. The media information interface will now be referred to as a media guide.

The media guide may display each piece of accessible media information in the area for a digital item, the area of a template, and the area of an application, i.e. the digital item, the template, and the application, so that the user can select the media information. Also, the media guide may be a type of template, and thus may be inserted into the area of a template.

The event executer 520 according to an exemplary embodiment of the present invention may select the media information based on a user direction imported through the media guide, and may perform at least one of inserting, deleting, exporting, importing, searching for, and publishing of the selected media information.

The event executer 520 according to an exemplary embodiment of the present invention may execute an event of the selected media information, based on a user direction imported through the media guide, in addition to operations related to editing of the media information.

The event executer 520 according to an exemplary embodiment of the present invention may call the media guide again when executing of the event of the media information is completed.

When the template is selected from the media information, the event executer 520 according to an exemplary embodiment of the present invention may search for digital items to determine the digital items to be associated with the template, display the found digital items, and select at least one of the displayed digital items. The event executer 520 according to an exemplary embodiment may insert an application generated by associating the selected digital item and the template to the media file.

When the application is selected from the media information, the event executer 520 according to an exemplary embodiment may execute an event for an associated digital item based on a template of the selected application.

According to an exemplary embodiment of the apparatus 500, when information of the application changes, the changed application may be inserted into the media file by updating existing association information according to association information of the changed template and digital item. According to another exemplary embodiment, when information of the application changes, the updated application may be inserted into the media file by recording only the changed information on the digital media associated with the existing template.

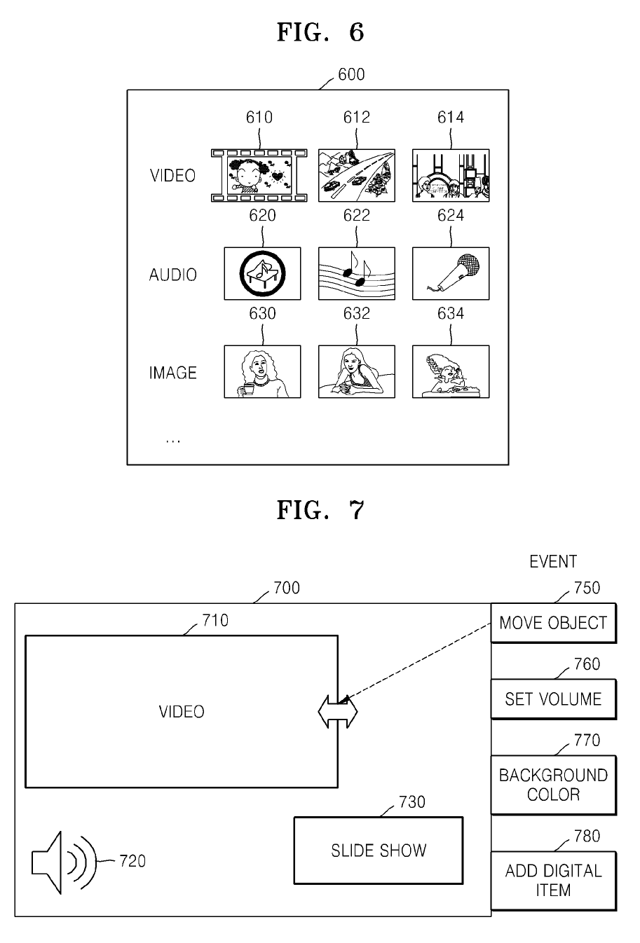

Exemplary embodiments of the media information will now be described with reference to FIGS. 6 through 8.

FIG. 6 is a diagram illustrating an example of a digital item 600.

The digital item 600 may include identification information about media resources, such as video 610, 612, 614, audio 620, 622, 624, and images 630, 632, and 634. The identification information may be an address, intrinsic information, etc. of a corresponding media resource in a media file.

FIG. 7 is a diagram illustrating an example of a template 700.

The template 700 defines reproduction areas 710, 720, and 730 of digital items, and events 750, 760, 770, and 780 of a digital item to be executed. The template 700 determines the reproduction area 710 of a ‘video’ digital item, the reproduction area 720 of an ‘audio’ digital item, and the reproduction area 730 of a ‘slide show’ digital item. A digital item related to ‘video’ content is matched to the reproduction area 710, a digital item related to ‘audio’ content is matched to the reproduction area 720, and a digital item related to ‘slide show’ content is matched to the reproduction area 730.

The template 700 defines the ‘move object’ event 750, the ‘set volume’ event 760, the ‘background color’ event 770, and the ‘add digital item’ event 780. The ‘move object’ event 750 defines a function of moving a location of an associated digital item, and the ‘set volume’ event 760 defines a function of setting a reproduction volume of an associated digital item. The ‘background color’ event 770 adjusts a background color of an associated digital item, and the ‘add digital item’ event 780 adds a new digital item to a corresponding template.

For example, when the template 700 associates the reproduction area 710 with the ‘move object’ event 750, the reproduction area 710 moves when the ‘move object’ event 750 is executed.

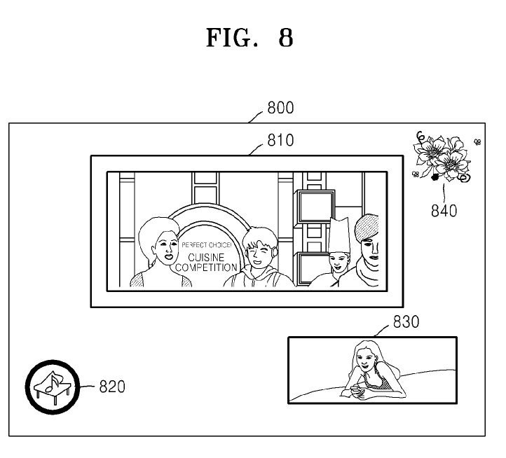

FIG. 8 is a diagram illustrating an example of an application 800.

The application 800 is generated by associating each of the reproduction areas 710, 720, and 730 of the template 700 with a suitable digital item. In other words, a digital item 810 related to a video item is associated with the reproduction area 710, a digital item 820 related to an audio item is associated with the reproduction area 720, and a digital item 830 related to a slide show is associated with the reproduction area 730. Also, a digital item 840 related to an image added by the ‘add digital item’ event 780 may be included in the application 800. By executing reproduction events of the digital items 810, 820, and 830 respectively associated with the reproduction areas 710, 720, and 730, a reproduction event of the application 800 is executed.

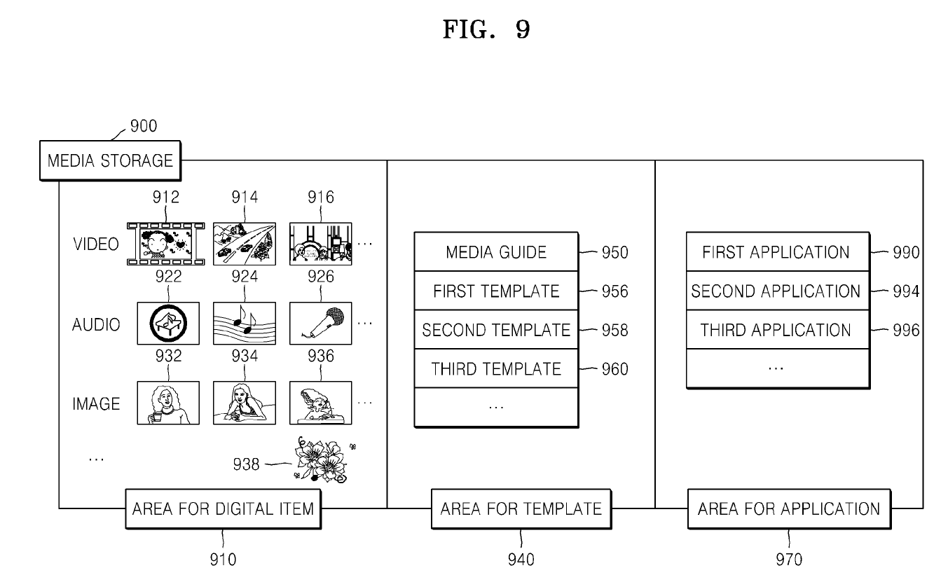

FIG. 9 is a diagram illustrating an example of a space for publishing media information.

In FIG. 9, media storage 900 is used as the example of a space for publishing media information. The media storage 900 includes an individual area for each type of media information. In other words, the media storage 900 separately includes an area 910 for a digital item, an area 940 for a template, and an area 970 for an application.

The area 910 includes information about at least one of resources 912, 914, and 916 for video content, at least one of media resources 922, 924, and 926 for audio content, and at least one of media resources 932, 934, 936, and 938 for image content.

The area 940 includes a media guide 950, a first template 956, a second template 958, and a third template 960. Since the media guide 950 is displayed on a screen in various formats according to a user input, the media guide 950 is regarded as one template, and thus is located on the top of the area 940.

Since the area 970 may include at least one application, the area 970 includes a first application 990, a second application 994, and a third application 996.

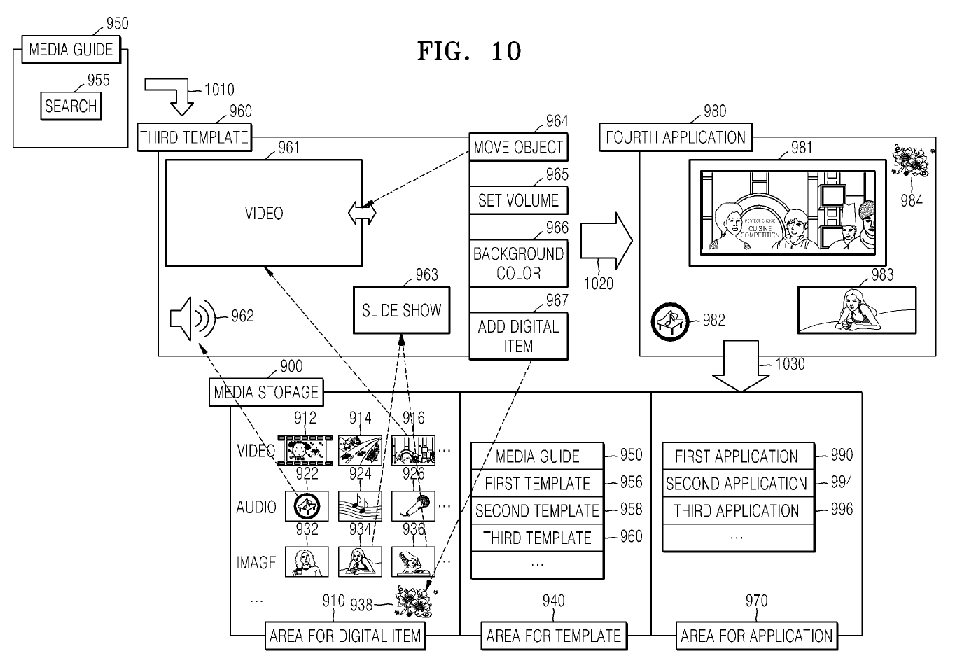

FIG. 10 is a diagram illustrating an interface between the apparatus 500 for executing a media file and a user, according to an exemplary embodiment of the present invention.

The event executer 520 of the apparatus 500 may call a media information interface. As described above, when the media guide 950 is called as the media information interface, the user may execute a ‘search’ event 955 that searches for accessible templates and applications. The media guide 950 accesses the area 940 and the area 970 of the media storage 900 and displays the media guide 950, the first through third templates 956 through 960, and the first through third applications 990 through 996, so that the user can check the accessible templates and applications.

When the user selects the third template 960 in operation 1010, the media guide 950 displays reproduction areas 961, 962, and 963 of digital items, and events 964, 965, 966, and 967.

The user may select and associate a desired digital item with each of the reproduction areas 961, 962, and 963 of the third template 960. For example, the media resource 916 for video content is associated with the reproduction area 961 for video content, the media resource 922 for audio content is associated with the reproduction area 962 for audio content, and the media resources 934 and 936 for image content are associated with the reproduction area 963 for slide show content. The media guide 950 accesses the area 910 of the media storage 900 so that the user may select a desired digital item.

The user may select a desired digital item to execute an event included in the third template 960. For example, the ‘move object’ event 964 may move the location of the reproduction area 961, and the media resource 938 may be associated as a digital item to execute the ‘add digital item’ event 967.

When a signal that editing of the third template 960 is completed is received in operation 1020, a fourth application 980 is generated due to an association relationship between the third template 960 and digital items, and an event setting. When the association relationship and the event set by the user are applied, the fourth application 980 may reproduce video content 981, audio content 982, and a slide show 983. Also, the location of the video content 981 may move, and image content 984 may be further included in the fourth application 980.

Since the fourth application 980 may be inserted into the area 970 of the media storage 900 in operation 1030, the apparatus 500 may publish an application edited by the user.

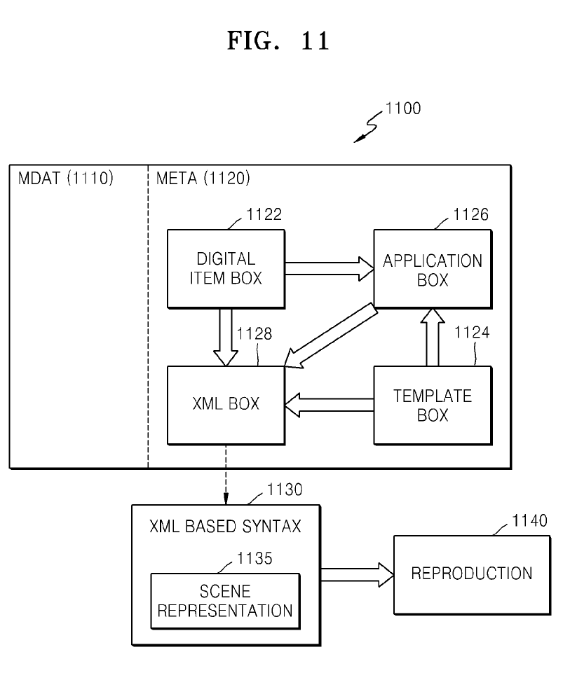

FIG. 11 is a diagram illustrating a media file 1100 generated in a box based file format according to an exemplary embodiment of the present invention.

A media file generated by the apparatus 400 or a media file used in the apparatus 500 may follow a box based file format. Hereinafter, an MPEG-21 file format is referred to as an example of the box based file format. However, the box based file format is not limited to the MPEG-21 file format.

The media file 1100 according to the MPEG-21 file format includes an mdat box 1110 to which a media resource is inserted, and a meta box 1120 to which various pieces of information about the media file 1100 are inserted. Also, the meta box 1120 includes an extensible markup language (XML) box 1128.

If the media file 1100 is generated by the apparatus 400, the meta box 1120 includes a digital item box 1122, a template box 1124, and an application box 1126 in addition to the XML box 1128. A digital item in the digital item box 1122 and a template in the template box 1124 may be associated with an application in the application box 1126, and a digital item in the digital item box 1122, a template in the template box 1124, and an application in the application box 1126 may be associated with information in the XML box 1128.

An XML based syntax 1130 is defined by XML information in the XML box 1128. An example of the XML based syntax 1130 includes an MPEG-21 digital item declaration (MPEG-21 DID). The MPEG-21 file format describes a scene representation 1135 by using the XML based syntax 1130, and an example of the scene representation 1135 includes a lightweight scene representation (LASeR). The media file 1100 is reproduced in operation 1140 by the XML based syntax 1130.

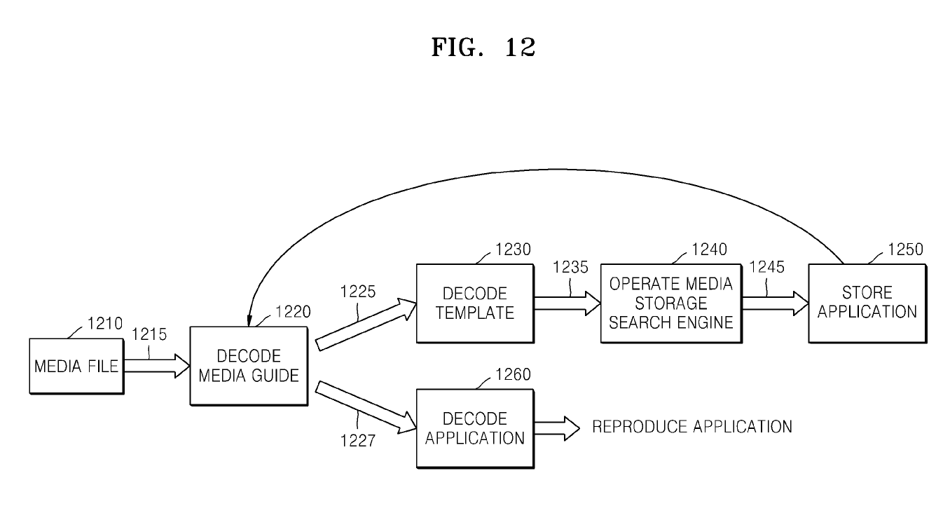

FIG. 12 is a diagram for describing the apparatus 500 for executing a media file executing an event, according to an exemplary embodiment of the present invention.

The apparatus 500 calls a media guide so as to execute a media file 1210 in operation 1215. In operation 1220, the media guide is decoded, and then executed. A user may select at least one of a template and an application displayed to be accessible by the media guide.

When the user selects the template in operation 1225, the selected template is decoded in operation 1230. When the user selects a digital item to be associated with the template in operation 1235, a media storage search engine is operated in operation 1240. When editing, such as associating the searched digital item with the template, is completed in operation 1245, an application is generated, and the generated application is published in an area of media storage in operation 1250. After the generated application is published in the media storage, the application may be searched for, or reproduced via the media guide.

When the user selects the application from the media guide in operation 1227, the selected application is decoded in operation 1260. Then, a digital item of the selected application and events of the digital item may be reproduced.

After executing the events about the application or the template, the media guide may be called again, and the user may select media information via the media guide.

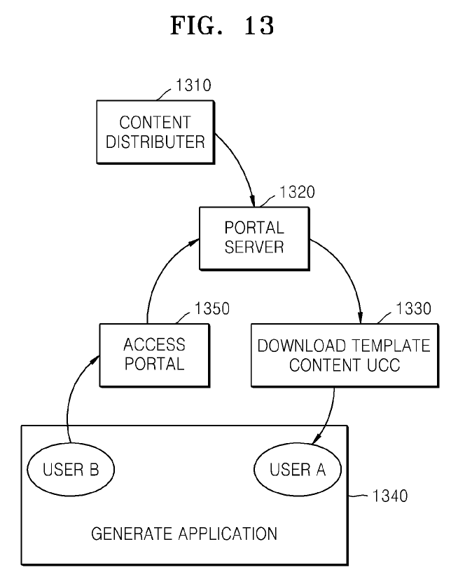

FIG. 13 is a diagram for describing how content is distributed by a media file, according to an exemplary embodiment of the present invention.

A content distributer manufactures a template in such a way that reproducing and editing of content are possible in one apparatus in operation 1310. The content distributer registers the template in a portal server 1320. A content distributer may be an expert developer of the content. For example, the template may be registered in a portal web site in a template content user created content (UCC) format. The template may be registered after being classified according to application categories. For example, a template for a slide show is registered in a slide show category.

General users (users A and B) may access the portal server in operation 1350 or download the template from the portal server in operation 1330. For example, a user may search for the template content UCC registered in the portal web site, and download template content UCC that is most similar to a desired application. An application is generated in operation 1340 when an editing operation is completed by associating the user's media resource with the downloaded template, and completing setting of a related event. When the user registers the generated application in the portal server, another user can download and use the application.

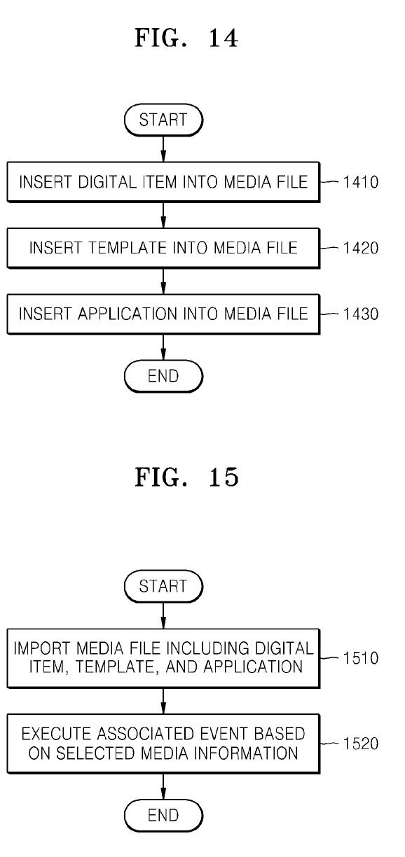

FIG. 14 is a flowchart of a method of generating a media file, according to an exemplary embodiment of the present invention.

In operation 1410, at least one digital item including identification information of an individual resource is inserted into a media file.

In operation 1420, at least one template including an event for the digital item and execution environment information of the event is inserted into the media file.

In operation 1430, at least one application including association information of the template and the digital item are inserted into the media file.

Media information including the digital item, the template, and the application may be imported or exported, and the media information and media resources associated with the media information may be simultaneously imported or exported. Also, the user may perform at least one of inserting, deleting, searching for, and publishing of the media information and the media resources.

The media file may follow a file format independently including an area for the digital item, an area for the template, and an area for the application.

FIG. 15 is a flowchart of a method of executing a media file, according to an exemplary embodiment of the present invention.

In operation 1510, a media file having recorded thereon media resources and media information, which includes at least one digital item, at least one template, and at least one application about the media resources, is imported.

The media file may follow a file format independently including an area for the digital item, an area for the template, and an area for the application. Media information having the same file format can be imported and exported. Also, the media information and the media resources associated with the media information may be simultaneously imported or exported.

In operation 1520, one piece of the media information is selected, and an event of a media resource associated with the selected media information is executed, based on the selected media information.

A media information interface may be called so that a user may access at least one of the area for the digital item, the area for the template, and the area for the application.

The media information is selected based on a user's instruction imported via the media information interface, and at least one operation of inserting, deleting, exporting, importing, searching for, and publishing of the selected media information may be performed. Also, based on the type of the selected media information, an event set about the media information may be executed. When executing of the event of the media information is completed, the media information interface may be called again.

According to the generating and executing of a media file of the present invention, various applications related to media can be generated with simple operations, and existing media data can be desirably edited. Also, an application generated or edited by various users can be published in one media file format or data format, and thus the application can be shared between users via various routes.

The above-described exemplary embodiments of the present invention can be written as computer programs and can be implemented in general-use digital computers that execute the programs using a computer readable recording medium or a storage medium. Examples of the computer readable recording medium include magnetic storage media (e.g., ROM, floppy disks, hard disks, etc.), optical recording media (e.g., CD-ROMs, or DVDs), and an example of the storage medium includes carrier waves (e.g., transmission through the Internet).

While this invention has been particularly shown and described with reference to preferred exemplary embodiments thereof, it will be understood by those of ordinary skill in the art that various changes in form and details may be made therein without departing from the spirit and scope of the invention as defined by the appended claims. The preferred exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of generating a media file comprising at least one media resource, the method comprising:
inserting at least one digital item comprising identification information of each of the at least one media resource into the media file;
inserting at least one template comprising at least one event for each of the at least one digital item and execution environment information of the at least one event into the media file; and
inserting at least one application comprising association information of the at least one template and the at least one digital item into the media file,
wherein media information comprising the at least one digital item, the at least one template, and the at least one application is adapted to be imported and exported.

2. The method of claim 1, wherein the media information and the at least one media resource associated with the media information are simultaneously imported.

3. The method of claim 1, wherein the media information and the at least one media resource associated with the media information are simultaneously exported.

4. The method of claim 1, wherein a user performs at least one of inserting, deleting, searching for, and publishing of at least one of the at least one media resource and the media information.

5. The method of claim 1, wherein in the inserting of the at least one template, the at least one digital item is associated with each of the at least one template, and the at least one event is executed for each of the at least one digital item.

6. The method of claim 1, wherein the media file follows a file format independently comprising a first area for the at least one digital item, a second area for the at least one template, and a third area for the at least one application.

7. A method of executing a media file comprising at least one media resource, the method comprising:
importing the media file comprising the at least one media resource and media information that comprises at least one digital item about the at least one media resource, at least one template, and at least one application; and
selecting one piece of the media information, and executing an event of the at least one media resource associated with the media information, based on the selected one piece of the media information,
wherein the at least one digital item comprises the at least one media resource and identification information of each of the at least one media resource, the at least one template comprises the event of the at least one digital item and execution environment information of the event, the at least one application comprises association information of the at least one template and the at least one digital item, and the media information is adapted to be imported and exported.

8. The method of claim 7, wherein the method further comprises importing the media information and the at least one media resource associated with the media information.

9. The method of claim 7, wherein the method further comprises exporting the media information and the at least one media resource associated with the media information.

10. The method of claim 7, wherein the media file follows a file format independently comprising a first area for the at least one digital item, a second area for the at least one template, and a third area for the at least one application.

11. The method of claim 10, wherein the selecting one piece of the media information and the executing of the event comprises a user calling a media information interface for accessing at least one of the first area for the at least one digital item, the second area for the at least one template, and the third area for the at least one application.

12. The method of claim 11, wherein the media information interface displays the media information in a first user accessible area for the at least one digital item, a second user accessible area for the at least one template, and a third user accessible area for the at least one application for the user to select the media information.

13. The method of claim 11, wherein the selecting one piece of the media information and the executing of the event further comprises:
selecting one piece of the media information based on the user direction received through the media information interface; and
performing at least one of inserting, deleting, exporting, importing, searching for, and publishing of the selected one piece of the media information.

14. The method of claim 11, wherein the selecting one piece of the media information and the executing of the event further comprises:
selecting one piece of the media information based on the user direction received through the media information interface; and
executing of the event of the selected one piece of the media information.

15. The method of claim 7, wherein the selecting one piece of the media information and the executing of the event comprises:
selecting a template among the at least one template from the media information;
searching for the at least one digital item so as to determine at least one digital item to be associated with the selected template;
displaying the at least one digital item;
selecting at least one of the displayed at least one digital item; and
inserting an application, among the at least one application, comprising association information of the selected at least one digital item and the selected template to the media file.

16. The method of claim 7, wherein the selecting one piece of the media information and the executing of the event comprises:
selecting an application among the at least one applications from the media information; and
executing an event for the at least one digital item associated with the at least one template of the selected application, based on the at least one template.

17. The method of claim 7, wherein when the association information of the at least one application changes, the changed at least one application is inserted into the media file by updating the association information of the at least one template and the at least one digital item according to the changed association information of the at least one template and the at least one digital item.

18. The method of claim 7, wherein when the association information of the at least one application changes, the at least one application is updated by recording only the changed association information from information about a digital media associated with the at least one template of the at least one application, and the updated at least one application is inserted into the media file.

19. An apparatus for generating a media file comprising at least one media resource, the apparatus comprising:
a digital item inserter which inserts at least one digital item comprising identification information of each of the at least one media resource to the media file;
a template inserter which inserts at least one template comprising an event for the at least one digital item and execution environment information of the event to the media file; and
an application inserter, which inserts at least one application comprising association information of the at least one template and the at least one digital item to the media file,
wherein media information comprising the at least one digital item, the at least one template, and the at least one application is adapted to be imported and exported.

20. An apparatus for executing a media file comprising at least one media resource, the apparatus comprising:
a media file importer which imports the media file comprising the at least one media resource and media information that comprises at least one digital item about the at least one media resource, at least one template, and at least one application; and
an event executer, which selects one piece of the media information and executes an event of the at least one media resource associated with the selected one piece of the media information, based on the selected one piece of the media information,
wherein the at least one digital item comprises the at least one media resource and identification information of each of the at least one media resource, the at least one template comprises an event of the at least one digital item and execution environment information of the event, the at least one application comprises association information of the at least one template and the at least one digital item, and the media information is adapted to be imported and exported.

21. A computer readable recording medium having recorded thereon a computer program for executing the method of claim 1.

22. A computer readable recording medium having recorded thereon a computer program for executing the method of claim 7.
